(19) United States
(12) Patent Application Publication
(10) Pub. No.: US 2026/0166888 A1
(43) Pub. Date: Jun. 18, 2026

(54) DRIVE METHOD OF LIQUID EJECTING APPARATUS AND LIQUID EJECTING APPARATUS

(71) Applicant: SEIKO EPSON CORPORATION, Tokyo (JP)

(72) Inventor: Madoka GOI, MATSUMOTO-SHI (JP)

(21) Appl. No.: 19/413,557

(22) Filed: Dec. 9, 2025

(30) Foreign Application Priority Data
Dec. 12, 2024 (JP) 2024-217354

(51) Int. Cl. B41J 2/185; B41J 2/17; B41J 2/175; B41J 29/393

(52) U.S. Cl. CPC B41J 2/185; B41J 2/1707; B41J 2/17596; B41J 29/393; B41J 2202/12

(57) ABSTRACT

A drive method of a liquid ejecting apparatus including a liquid ejecting head that includes a nozzle that ejects liquid, an individual flow path that communicates with the nozzle and discharges liquid that is not ejected from the nozzle while supplying liquid to the nozzle, and a drive element that drives so that pressure fluctuation occurs in the liquid in the individual flow path according to a supplied drive signal, a circulation control section that controls a circulation operation of circulating the liquid in the individual flow path, and a print condition information acquisition section that acquires print condition information regarding a print condition on a recording medium of the liquid ejected from the nozzle, includes controlling a flow velocity of the liquid in the individual flow path based on the print condition information via the circulation control section.

The present application is based on, and claims priority from JP Application Serial Number 2024-217354, filed Dec. 12, 2024, the disclosure of which is hereby incorporated by reference herein in its entirety.

### BACKGROUND

### 1. Technical Field

The present disclosure relates to a drive method of a liquid ejecting apparatus and a liquid ejecting apparatus.

### 2. Related Art

In a liquid ejecting apparatus typified by an ink jet printer, there is a case where a configuration is adopted in which liquid such as ink is circulated inside and outside a liquid ejecting head that ejects the liquid. For example, JP-A-2008-142910 discloses a printer that circulates ink in a head and suppresses thickening of the ink in the vicinity of an ejection hole of a nozzle in order to prevent deterioration of ejection characteristics due to evaporation and thickening of a volatile component of the ink in the nozzle.

When the circulation flow rate is constant, a printing quality defect occurs or power is wasted due to the excess or deficiency of the circulation amount of the ink.

### SUMMARY

In order to solve the above problems, according to an aspect of the present disclosure, there is provided a drive method of a liquid ejecting apparatus including a liquid ejecting head that includes a nozzle that ejects liquid, an individual flow path that communicates with the nozzle and discharges liquid that is not ejected from the nozzle while supplying liquid to the nozzle, and a drive element that drives so that pressure fluctuation occurs in the liquid in the individual flow path according to a supplied drive signal, a circulation control section that controls a circulation operation of circulating the liquid in the individual flow path, and a print condition information acquisition section that acquires print condition information regarding a print condition on a recording medium of the liquid ejected from the nozzle, the drive method including controlling a flow velocity of the liquid in the individual flow path based on the print condition information via the circulation control section.

According to an aspect of the present disclosure, there is provided a liquid ejecting apparatus including a liquid ejecting head that includes a nozzle that ejects liquid, an individual flow path that communicates with the nozzle and discharges liquid that is not ejected from the nozzle while supplying liquid to the nozzle, and a drive element that drives so that pressure fluctuation occurs in the liquid in the individual flow path according to a supplied drive signal, a circulation control section that controls a circulation operation of circulating the liquid in the individual flow path, and a print condition information acquisition section that acquires print condition information regarding a print condition on a recording medium of the liquid ejected from the nozzle, in which the circulation control section controls a flow velocity of the liquid in the individual flow path based on the print condition information.

### BRIEF DESCRIPTION OF THE DRAWINGS

FIG. 1 is a schematic view illustrating a configuration example of a liquid ejecting apparatus according to a first embodiment.

FIG. 2 is a view illustrating a configuration example of a circulation mechanism.

FIG. 3 is an exploded perspective view of a head chip of a liquid ejecting head.

FIG. 4 is a cross-sectional view taken along the line IV-IV in FIG. 3.

FIG. 5 is a view illustrating a relationship between a circulation flow rate by the circulation mechanism and a landing deviation amount of liquid on a recording medium.

FIG. 6 is a view illustrating the relationship between the circulation flow rate by the circulation mechanism and the landing deviation amount of the liquid on the recording medium.

FIG. 7 is a view illustrating a relationship between a distance between a nozzle surface and the recording medium and a circulation flow rate by the circulation mechanism.

FIG. 8 is an explanatory view of a drive signal.

FIG. 9 is a schematic view illustrating a configuration example of a liquid ejecting apparatus according to a second embodiment.

FIG. 10 is a view illustrating a relationship between bleed resistance of the liquid on the recording medium and the circulation flow rate by the circulation mechanism.

FIG. 11 is a schematic view illustrating a configuration example of a liquid ejecting apparatus according to a third embodiment.

FIG. 12 is a view illustrating a relationship between image quality and the circulation flow rate by the circulation mechanism.

### DESCRIPTION OF EMBODIMENTS

Preferred embodiments according to the present disclosure will be described below with reference to the accompanying drawings. In the drawings, dimensions and scales of each section are appropriately different from the actual dimensions and scales, and some portions are schematically illustrated for easy understanding. Further, the scope of the present disclosure is not limited to the embodiments unless it is stated that the present disclosure is particularly limited in the following description.

For convenience, an X axis, a Y axis, and a Z axis intersecting with each other will be appropriately used in the following description. In the following, one direction along the X axis is an X1 direction, and a direction opposite to the X1 direction is an X2 direction. Similarly, directions opposite to each other along the Y axis are a Y1 direction and a Y2 direction. Further, directions opposite to each other along the Z axis are a Z1 direction and a Z2 direction.

Here, typically, the Z axis is a vertical axis, and the Z2 direction corresponds to a downward direction in the vertical direction. Meanwhile, the Z axis need not be the vertical axis. In addition, the X axis, the Y axis, and the Z axis are typically orthogonal to each other, but are not limited thereto, and need only intersect each other at, for example, an angle within a range of 80° or more and 100° or less.

### 1. First Embodiment

### 1-1. Schematic Configuration of Liquid Ejecting Apparatus

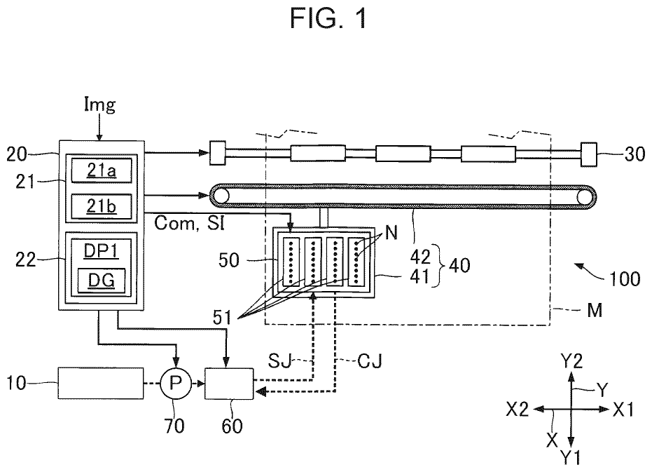

FIG. 1 is a schematic view illustrating a configuration example of a liquid ejecting apparatus 100 according to a first embodiment. The liquid ejecting apparatus 100 is an ink jet printing apparatus that ejects ink, which is an example of liquid, to a recording medium M as liquid droplets. The recording medium M is typically printing paper. The recording medium M is not limited to the printing paper, and may be, for example, a printing target having any material such as a resin film or fabric.

As illustrated in FIG. 1, the liquid ejecting apparatus 100 includes a liquid container 10, a control unit 20, a transport mechanism 30, a movement mechanism 40, a liquid ejecting head 50, a circulation mechanism 60, and a pump 70. Hereinafter, all of the above-described elements will be briefly described in order based on FIG. 1.

The liquid container 10 stores ink. Specific aspects of the liquid container 10 include, for example, a cartridge that can be attached to and detached from the liquid ejecting apparatus 100, a bag-shaped ink pack formed of a flexible film, and an ink tank that can be refilled with ink.

The ink stored in the liquid container 10 is not particularly limited, and may be, for example, aqueous ink in which a coloring material such as a dye or a pigment is dissolved in an aqueous solvent, solvent-based ink in which a coloring material is dissolved in an organic solvent, UV-curable ink, clear ink, white ink, or a treatment solution. The clear ink does not contain a coloring material, and is ink for improving scratch resistance of a printed surface printed with a coloring material by overcoating the printed surface, or for reducing color deviations due to irregular reflection by reducing unevenness caused by a pigment component. The white ink contains a white pigment and the like, and is ink for reducing non-whiteness caused by dirt on the recording medium M or the like. The treatment solution has reactivity with a component contained in coloring material ink, and is ink for improving fixability of the coloring material ink or the like by coming into contact with the coloring material ink on the recording medium M. The liquid container 10 may have a plurality of containers for storing different types of ink for each of the plurality of head chips 51 described later.

The control unit 20 controls an operation of each element of the liquid ejecting apparatus 100. The control unit 20 includes a processing circuit 21 such as a central processing unit (CPU) or a field programmable gate array (FPGA), and a storage circuit 22 such as a semiconductor memory.

Here, the processing circuit 21 functions as a print condition information acquisition section 21a and a circulation control section 21b. Therefore, the liquid ejecting apparatus 100 includes the circulation control section 21b and the print condition information acquisition section 21a. The print condition information acquisition section 21a acquires print condition information DP1. The acquired print condition information DP1 is stored in the storage circuit 22. The circulation control section 21b controls a circulation operation of circulating ink in an individual flow path PJ, which will be described later. In particular, the circulation control section 21b controls a flow velocity of the ink in the individual flow path PJ, which will be described later, based on the print condition information DP1. Therefore, even when a print condition is changed, a circulation amount of the ink can be optimized. As a result, it is possible to reduce the printing quality defect and the waste of power.

The print condition information DP1 is information regarding a print condition on the recording medium M of ink ejected from the nozzle N described later. In the present embodiment, the print condition information DP1 includes distance information DG as information regarding the print condition on the recording medium M of the ink ejected from the nozzle N. The distance information DG is information indicating a distance PG between a nozzle surface FN, which will be described later, and the recording medium M at the time of printing. Therefore, in the present embodiment, the print condition information acquisition section 21a acquires the distance information DG. The acquisition is performed, for example, by measurement using a sensor such as an optical sensor (not illustrated) that measures the distance PG, or by input such as setting by the user.

The transport mechanism 30 transports the recording medium M in the Y1 direction under the control by the control unit 20. The movement mechanism 40 causes a plurality of the liquid ejecting heads 50 to reciprocate in the X1 direction and the X2 direction under the control by the control unit 20. In the example illustrated in FIG. 1, the movement mechanism 40 includes a substantially box-shaped transport body 41 called a carriage that accommodates the liquid ejecting head 50, and a transport belt 42 to which the transport body 41 is fixed. In addition to the plurality of liquid ejecting heads 50, a part of the circulation mechanism 60 may be mounted on the transport body 41.

The liquid ejecting head 50 ejects ink supplied from the liquid container 10 via the pump 70 and the circulation mechanism 60 in this order from each of a plurality of the nozzles N in the Z2 direction toward the recording medium M under the control by the control unit 20. The ejection is performed in parallel with the transport of the recording medium M by the transport mechanism 30 and the reciprocating movement of the liquid ejecting head 50 by the movement mechanism 40, thereby forming an image by the ink on a surface of the recording medium M.

Here, the liquid ejecting head 50 is supplied with a drive signal Com for driving the liquid ejecting head 50 and a control signal SI for controlling the drive of the liquid ejecting head 50 from the control unit 20. The control signal SI is a signal for designating whether or not to supply the drive signal Com to a drive element 51e, which will be described later, of the liquid ejecting head 50 and is generated based on image data Img. The image data Img is information indicating an image, and is supplied to the control unit 20 from a host computer such as a personal computer or a digital camera.

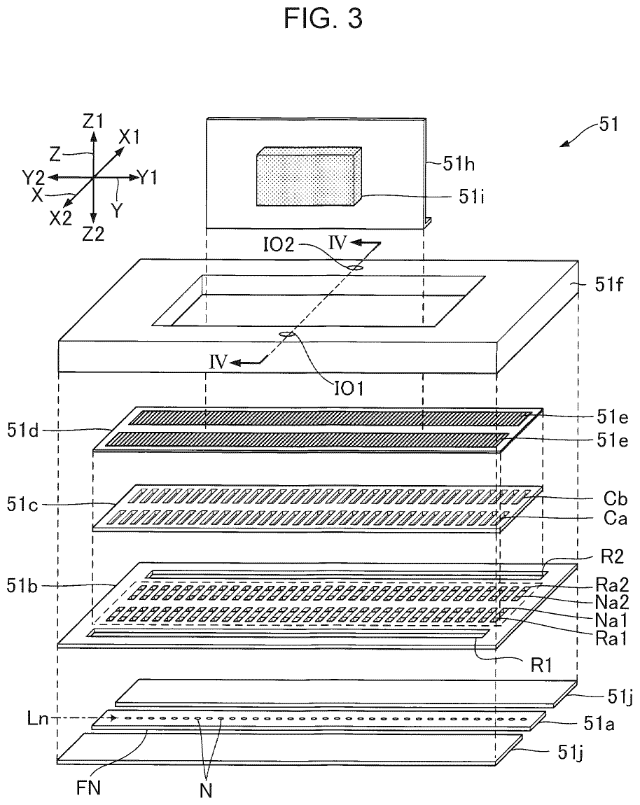

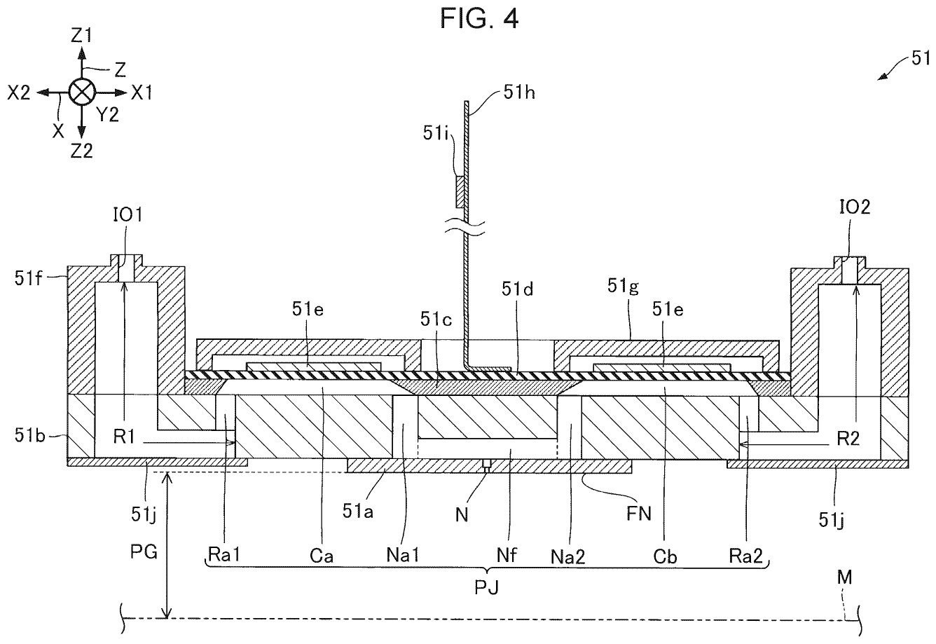

In the example illustrated in FIG. 1, the liquid ejecting head 50 has a plurality of head chips 51. Each of the plurality of head chips 51 is coupled to a supply flow path SJ and a collection flow path CJ via a flow path of a flow path structure (not illustrated). Details of the head chips 51 will be described later based on FIGS. 3 and 4. The number of the head chips 51 included in the liquid ejecting head 50 is not limited to the example illustrated in FIG. 1, and the number may be any number, and may be a single number. In addition, the disposition of the head chips 51 in the liquid ejecting head 50 is not limited to the example illustrated in FIG. 1, and is any disposition.

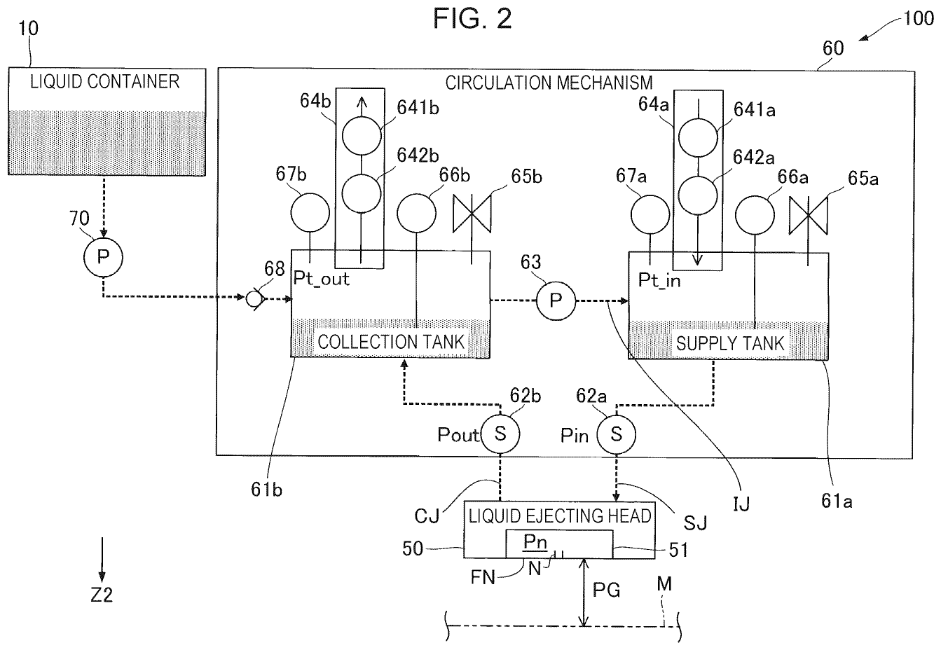

In the example illustrated in FIG. 1, the liquid container 10 is coupled to the liquid ejecting head 50 via the pump 70 and the circulation mechanism 60 in this order. The circulation mechanism 60 is a mechanism that supplies ink to the liquid ejecting head 50 via the supply flow path SJ and collects ink discharged from the liquid ejecting head 50 via the collection flow path CJ for resupply to the liquid ejecting head 50, under the control by the control unit 20. With the operation of the circulation mechanism 60, an increase in viscosity of the ink can be suppressed, or accumulated air bubbles in the ink can be reduced. Each of the supply flow path SJ and the collection flow path CJ is formed of, for example, a flexible tube. A specific configuration example of the circulation mechanism 60 will be described later based on FIG. 2.

The pump 70 supplies the ink stored in the liquid container 10 to the circulation mechanism 60 under the control by the control unit 20. The pump 70 is, for example, a tube pump. The pump 70 is not limited to the tube pump, and may be, for example, a diaphragm pump or a syringe pump.

### 1-2. Configuration of Circulation Mechanism

FIG. 2 is a view illustrating a configuration example of the circulation mechanism 60. Hereinafter, an example of the configuration of the circulation mechanism 60 will be described based on FIG. 2. The configuration of the circulation mechanism 60 may be any as long as the ink in the individual flow path PJ of the head chip 51, which will be described later, can be circulated, and is not limited to the example illustrated in FIG. 2.

As illustrated in FIG. 2, the circulation mechanism 60 includes a supply tank 61a, a collection tank 61b, pressure sensors 62a and 62b, a return pump 63, a pressurizing mechanism 64a, a depressurizing mechanism 64b, on-off valves 65a and 65b, liquid level sensors 66a and 66b, pressure sensors 67a and 67b, and a check valve 68.

The supply tank 61a is a container that temporarily stores the ink to be supplied to the liquid ejecting head 50. The supply tank 61a is coupled to the liquid ejecting head 50 via the supply flow path SJ, and the ink in the supply tank 61a is supplied to the liquid ejecting head 50 via the supply flow path SJ. Further, the supply tank 61a is coupled to the collection tank 61b via a relay flow path IJ, and receives the supply of the ink from the collection tank 61b via the relay flow path IJ.

Here, the pressure sensor 62a is provided in the middle of the supply flow path SJ. The pressure sensor 62a is a sensor for measuring a pressure Pin between the pressurizing mechanism 64a and the liquid ejecting head 50, and measures a pressure in the supply flow path SJ. The pressure sensor 62a is not particularly limited, and for example, a known diaphragm-type pressure sensor can be used. Information indicating a measurement result of the pressure sensor 62a is input to the control unit 20.

The return pump 63 is provided in the middle of the relay flow path IJ. The return pump 63 is a pump that generates a pressure for transferring ink from the collection tank 61b to the supply tank 61a under the control by the control unit 20, and is, for example, a tube pump.

The supply tank 61a is provided with a pressurizing mechanism 64a, an on-off valve 65a, a liquid level sensor 66a, and a pressure sensor 67a.

The pressurizing mechanism 64a is a mechanism for pressurizing the inside of the supply tank 61a, and performs a pressurizing operation for supplying ink to a first common liquid chamber R1. In the example illustrated in FIG. 2, the pressurizing mechanism 64a includes a compressor 641a and a regulator 642a. The compressor 641a generates a positive pressure higher than the atmospheric pressure. The regulator 642a is provided between the compressor 641a and the supply tank 61a, adjusts the pressure generated by the compressor 641a, and supplies the adjusted pressure to the supply tank 61a under the control by the control unit 20. The pressurizing mechanism 64a may have a pump such as a tube pump, a syringe pump, or a diaphragm pump instead of the compressor 641a.

The on-off valve 65a is a valve mechanism that opens and closes the space between the inside of the supply tank 61a and the outside space under the control by control unit 20. When the on-off valve 65a is in an open state, the inside of the supply tank 61a is open to the atmosphere, and when the on-off valve 65a is in a closed state, the supply tank 61a is sealed. The on-off valve 65a may be, for example, any valve as long as the on-off valve 65a can be controlled from a device such as the control unit 20, and is, for example, a diaphragm valve, a solenoid valve, an electric valve, or the like.

The liquid level sensor 66a detects whether or not a liquid level of the ink in the supply tank 61a is equal to or higher than a predetermined height. The liquid level sensor 66a is not particularly limited, and for example, a known contact or non-contact liquid level sensor can be used. Information indicating the detection result of the liquid level sensor 66a is input to the control unit 20.

The pressure sensor 67a measures a pressure Pt_in in the supply tank 61a. The pressure sensor 67a is not particularly limited, and for example, a known diaphragm-type pressure sensor can be used. Information indicating the measurement result of the pressure sensor 67a is input to the control unit 20.

The collection tank 61b is a container that temporarily stores the ink discharged from the liquid ejecting head 50. The collection tank 61b is coupled to the liquid ejecting head 50 via the collection flow path CJ, and receives the supply of the ink collected from the liquid ejecting head 50 via the collection flow path CJ. Further, the collection tank 61b communicates with the liquid container 10 via the pump 70 and receives the supply of the ink from the liquid container 10.

Here, the pressure sensor 62b is provided in the middle of the collection flow path CJ. The pressure sensor 62b is a sensor for measuring a pressure Pout between the depressurizing mechanism 64b and the liquid ejecting head 50, and measures a pressure in the collection flow path CJ. The pressure sensor 62b is not particularly limited, and for example, a known diaphragm-type pressure sensor can be used. Information indicating the measurement result of the pressure sensor 62b is input to the control unit 20.

The check valve 68 is provided between the collection tank 61b and the pump 70. The check valve 68 suppresses the ink supplied from the liquid container 10 to the collection tank 61b from flowing back.

The collection tank 61b is provided with the depressurizing mechanism 64b, the on-off valve 65b, the liquid level sensor 66b, and the pressure sensor 67b.

The depressurizing mechanism 64b is a mechanism for depressurizing the inside of the collection tank 61b, and performs a depressurization operation for discharging ink from a second common liquid chamber R2. In the example illustrated in FIG. 2, the depressurizing mechanism 64b includes a vacuum pump 641b and a regulator 642b. The vacuum pump 641b generates a negative pressure lower than the atmospheric pressure. The regulator 642b is provided between the vacuum pump 641b and the collection tank 61b, and adjusts the pressure generated by the vacuum pump 641b, and supplies the adjusted pressure to the collection tank 61b under the control by the control unit 20.

The on-off valve 65b is a valve mechanism that opens and closes the space between the collection tank 61b and the outside space under the control by the control unit 20. When the on-off valve 65b is in an open state, the inside of the collection tank 61b is open to the atmosphere, and when the on-off valve 65b is in a closed state, the collection tank 61b is sealed. The on-off valve 65b may be, for example, any valve as long as the on-off valve 65b can be controlled from a device such as the control unit 20, and is, for example, a diaphragm valve, a solenoid valve, an electric valve, or the like.

The liquid level sensor 66b detects whether or not the liquid level of the ink in the collection tank 61b is equal to or higher than a predetermined height. The liquid level sensor 66b is not particularly limited, and for example, a known contact or non-contact liquid level sensor can be used. Information indicating the detection result of the liquid level sensor 66b is input to the control unit 20.

The pressure sensor 67b measures a pressure Pt_out in the collection tank 61b. The pressure sensor 67b is not particularly limited, and for example, a known diaphragm-type pressure sensor can be used. Information indicating the measurement result of the pressure sensor 67b is input to the control unit 20.

The above circulation mechanism 60 circulates ink in a circulation path including the liquid ejecting head 50, the supply tank 61a, the supply flow path SJ, the collection tank 61b, the collection flow path CJ, and the relay flow path IJ by increasing the pressure Pt_in in the supply tank 61a to be higher than the pressure Pt_out in the collection tank 61b under the control by the control unit 20. At this time, the ink flows from the supply tank 61a into the liquid ejecting head 50 via the supply flow path SJ, and the ink is collected from the liquid ejecting head 50 to the collection tank 61b via the collection flow path CJ. Further, as necessary, the ink is transferred from the collection tank 61b to the supply tank 61a via the relay flow path IJ by the operation of the return pump 63.

Here, the control unit 20 controls the operations of the pressurizing mechanism 64a and the depressurizing mechanism 64b so that the pressure Pn in the liquid ejecting head 50 is maintained at a negative pressure within a predetermined range, based on the detection results of the pressure sensors 62a and 62b. By maintaining the pressure Pn at a negative pressure within the predetermined range, breaking of meniscus of the ink in the nozzle N is prevented, and ink dripping from the nozzle N is prevented.

### 1-3. Configuration of Head Chip

FIG. 3 is an exploded perspective view of the head chip 51 of the liquid ejecting head 50. FIG. 4 is a cross-sectional view taken along the line IV-IV in FIG. 3. The line IV-IV in FIG. 3 is a virtual line segment that is parallel to the X axis and passes through a nozzle flow path Nf.

As illustrated in FIGS. 3 and 4, the head chip 51 is provided with the plurality of nozzles N, a plurality of the individual flow paths PJ, the first common liquid chamber R1, and the second common liquid chamber R2. Here, the first common liquid chamber R1 and the second common liquid chamber R2 communicate with each other via the plurality of individual flow paths PJ. Each individual flow path PJ communicates with the corresponding nozzle N, and discharges the ink that is not ejected from the nozzle N while supplying ink to the nozzle N. Each individual flow path PJ includes a pressure chamber Ca, a pressure chamber Cb, the nozzle flow path Nf, an individual supply flow path Ra1, an individual discharge flow path Ra2, a first communication flow path Na1, and a second communication flow path Na2.

The head chip 51 includes a nozzle substrate 51a, a flow path substrate 51b, a pressure chamber substrate 51c, a vibration plate 51d, a plurality of the drive elements 51e, a case 51f, a protective plate 51g, a wiring substrate 51h, and a vibration absorber 51j.

As illustrated in FIGS. 3 and 4, the nozzle substrate 51a, the flow path substrate 51b, the pressure chamber substrate 51c, and the vibration plate 51d are laminated in this order in the Z1 direction. Each of the members extends along the Y axis and is manufactured, for example, by processing a single-crystal silicon substrate using semiconductor processing technology. Further, the members are bonded to each other with an adhesive or the like. Another layer such as an adhesive layer or a substrate may be appropriately interposed between two adjacent members among the members.

The nozzle substrate 51a is provided with the plurality of nozzles N for ejecting ink. Each of the plurality of nozzles N is a through-hole through which ink passes, and penetrates the nozzle substrate 51a. The plurality of nozzles N are arranged in the direction along the Y axis to constitute a nozzle row Ln. A surface of the nozzle substrate 51a facing the Z2 direction is the nozzle surface FN. The plurality of nozzles N open on the nozzle surface FN.

The flow path substrate 51b is provided with a part of each of the first common liquid chamber R1 and the second common liquid chamber R2 and a portion of the plurality of individual flow paths PJ excluding the pressure chamber Ca and the pressure chamber Cb. That is, the flow path substrate 51b is provided with the nozzle flow path Nf, the first communication flow path Na1, the second communication flow path Na2, the individual supply flow path Ra1, and the individual discharge flow path Ra2. In the following, each of the pressure chamber Ca and the pressure chamber Cb may be referred to as a pressure chamber C.

The part of each of the first common liquid chamber R1 and the second common liquid chamber R2 is a space that penetrates the flow path substrate 51b. The vibration absorber 51j that blocks an opening by the space is installed on a surface of the flow path substrate 51b facing the Z2 direction.

The vibration absorber 51j is a sheet-shaped member formed of an elastic material. The vibration absorber 51j constitutes a part of the wall surface of each of the first common liquid chamber R1 and the second common liquid chamber R2, and absorbs pressure fluctuation in the first common liquid chamber R1 and the second common liquid chamber R2.

The nozzle flow path Nf is a space in a groove provided on the surface of the flow path substrate 51b facing the Z2 direction. Here, the nozzle substrate 51a constitutes a part of the wall surface of the nozzle flow path Nf.

Each of the first communication flow path Na1 and the second communication flow path Na2 is a space that penetrates the flow path substrate 51b.

Each of the individual supply flow path Ra1 and the individual discharge flow path Ra2 is a space that penetrates the flow path substrate 51b. The individual supply flow path Ra1 causes the first common liquid chamber R1 and the pressure chamber Ca to communicate with each other, and supplies the ink from the first common liquid chamber R1 to the pressure chamber Ca. Here, one end of the individual supply flow path Ra1 opens on a surface of the flow path substrate 51b facing the Z1 direction. On the other hand, the other end of the individual supply flow path Ra1 is an upstream end of the individual flow path PJ and is an opening on the wall surface of the first common liquid chamber R1 in the flow path substrate 51b. On the other hand, the individual discharge flow path Ra2 causes the second common liquid chamber R2 and the pressure chamber Cb to communicate with each other, and discharges the ink from the pressure chamber Cb to the second common liquid chamber R2. Here, one end of the individual discharge flow path Ra2 opens on the surface of the flow path substrate 51b facing the Z1 direction. On the other hand, the other end of the individual discharge flow path Ra2 is a downstream end of the individual flow path PJ, and is an opening of the wall surface of the second common liquid chamber R2 in the flow path substrate 51b.

The pressure chamber substrate 51c is provided with the pressure chambers Ca and the pressure chambers Cb of the plurality of individual flow paths PJ. Each of the pressure chamber Ca and the pressure chamber Cb penetrates the pressure chamber substrate 51c and is a gap between the flow path substrate 51b and the vibration plate 51d.

The vibration plate 51d is a plate-shaped member that can elastically vibrate. The vibration plate 51d is, for example, a laminate including a first layer formed of silicon oxide and a second layer formed of zirconium oxide. Here, another layer such as a metal oxide may be interposed between the first layer and the second layer. Further, a part or all of the vibration plate 51d may be integrally formed of the same material as the pressure chamber substrate 51c. For example, the vibration plate 51d and the pressure chamber substrate 51c can be integrally formed by selectively removing a part in a thickness direction of a region corresponding to the pressure chamber C in a plate-shaped member having a predetermined thickness. Further, the vibration plate 51d may be formed of a layer of a single material.

The plurality of drive elements 51e corresponding to the pressure chambers C different from each other are installed on a surface of the vibration plate 51d facing the Z1 direction. In the illustrated example, each of the drive elements 51e is a piezoelectric element, and is formed by, for example, laminating a first electrode and a second electrode facing each other and a piezoelectric layer disposed between the first electrode and the second electrode. Each of the drive elements 51e causes the pressure of the ink in the pressure chamber C to fluctuate, thereby ejecting the ink in the pressure chamber C from the nozzle N. When the drive signal Com is supplied, the drive element 51e vibrates the vibration plate 51d with the deformation of the drive element 51e. The pressure chamber C is expanded and contracted due to the vibration, so that the pressure of the ink in the pressure chamber C fluctuates. As described above, the drive element 51e drives so that pressure fluctuation occurs in the ink in the individual flow path PJ according to the supplied drive signal Com. The drive element 51e is not limited to the piezoelectric element, and may be, for example, a heat-generating element.

The case 51f is a case for storing ink. The case 51f is provided with a space constituting a remaining portion other than a part provided on the flow path substrate 51b for each of the first common liquid chamber R1 and the second common liquid chamber R2. In addition, the case 51f is provided with an introduction port IO1 communicating with the first common liquid chamber R1 and a discharge port IO2 communicating with the second common liquid chamber R2. Ink is supplied to the first common liquid chamber R1 via the introduction port IO1. In addition, ink stored in the second common liquid chamber R2 is collected via the discharge port IO2.

The protective plate 51g is a plate-shaped member installed on the surface of the vibration plate 51d facing the Z1 direction, protects the plurality of drive elements 51e, and reinforces the mechanical strength of the vibration plate 51d. Here, a space for accommodating the plurality of drive elements 51e is formed between the protective plate 51g and the vibration plate 51d.

The wiring substrate 51h is a mounting component that is mounted on the surface of the vibration plate 51d facing the Z1 direction and that electrically couples the control unit 20 and the head chip 51. For example, a flexible wiring substrate 51h such as a flexible printed circuit (FPC) or a flexible flat cable (FFC) is preferably used. A drive circuit 51i is mounted on the wiring substrate 51h. The drive circuit 51i is a circuit including a switching element that switches whether or not to supply at least a part of the waveform included in the drive signal Com as a drive pulse, based on the control signal SI.

In the head chip 51 with the above configuration, the drive elements 51e corresponding to both the pressure chamber Ca and the pressure chamber Cb are simultaneously driven by the drive signal Com from the drive circuit 51i, so that the pressure in the pressure chamber Ca and the pressure chamber Cb is fluctuated, and the ink is ejected from the nozzle N in accordance with the pressure fluctuation. When a printing operation is performed on the recording medium M, the ink ejected from the nozzle N lands on the recording medium M.

Further, by the operation of the circulation mechanism 60 described above, the ink flows through the first common liquid chamber R1, the individual supply flow path Ra1, the pressure chamber Ca, the nozzle flow path Nf, the pressure chamber Cb, the individual discharge flow path Ra2, and the second common liquid chamber R2 in this order. By performing the circulation operation of circulating the ink in the individual flow path PJ in this manner, it is possible to reduce the thickening of the ink ejected from the nozzle N. As a result, it is possible to reduce the deterioration of the landing accuracy of the ink on the recording medium M due to the thickening of the ink ejected from the nozzle N.

### 1-4. Relationship Between Circulation Flow Rate and Landing Deviation

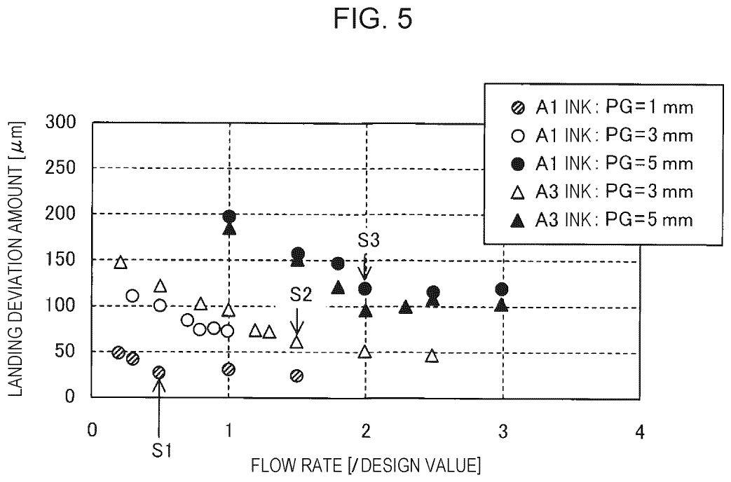

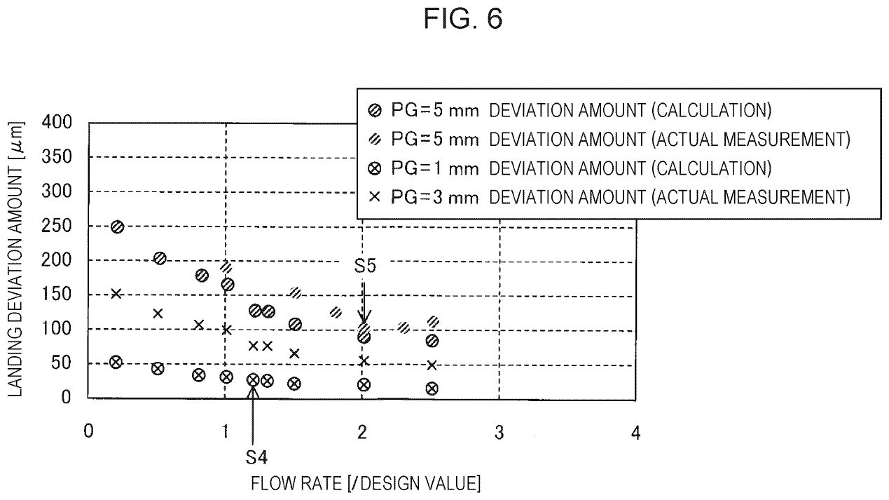

FIGS. 5 and 6 are views illustrating a relationship between a circulation flow rate by the circulation mechanism 60 and a landing deviation amount of liquid on the recording medium M. In FIG. 5, the measurement result, which is obtained by the actual measurement of the relationship between the deviation amount of the landing position at the time when A1 ink is ejected toward the recording medium M and the distance PG is 1 mm, 3 mm, and 5 mm, and the circulation flow rate by the circulation mechanism 60, is illustrated, and the measurement result, which is obtained by the actual measurement of the relationship between the deviation amount of the landing position at the time when A3 ink having a type (viscosity) different from the A1 ink is ejected toward the recording medium M and the distance PG is 3 mm and 5 mm, and the circulation flow rate by the circulation mechanism 60, is illustrated. In FIG. 6, the measurement result when the distance PG is 3 mm and 5 mm among the measurement results obtained by the actual measurement illustrated in FIG. 5 is illustrated, and the result of the theoretical value obtained by calculating the relationship between the deviation amount of the landing position and the flow rate when the distance PG is 1 mm and 5 mm by using the measurement result obtained by the actual measurement when the distance PG is 3 mm is illustrated. In FIGS. 5 and 6, the horizontal axis indicates a flow rate as a relative value normalized with respect to the design value of a certain flow rate.

In the liquid ejecting head 50, when the viscosity of the ink in the vicinity of the nozzle N increases due to the evaporation of a volatile component in the ink from the nozzle N, the speed of the ink ejected from the nozzle N changes. Thus, the landing accuracy of the ink on the recording medium M deteriorates. Therefore, the increase in viscosity of the ink in the vicinity of the nozzle N is reduced by circulating the ink in the individual flow path PJ by the operation of the circulation mechanism 60.

Here, as illustrated in FIGS. 5 and 6, as the flow rate of the ink in the individual flow path PJ is increased, the landing deviation amount of the ink on the recording medium M is saturated. That is, as the flow rate of the ink in the individual flow path PJ is increased, in a region where the flow rate is less than a certain flow rate, the landing deviation amount of the ink on the recording medium M is reduced in accordance with the increase in flow rate. However, in a region where the flow rate is the certain flow rate or more, even when the flow rate is increased, the effect of reducing the landing deviation amount of the ink on the recording medium M is almost unchanged and saturated. Therefore, when the flow rate at the time of saturation at the predetermined distance PG is set as the design value of the ink flow rate in the individual flow path PJ, the effect of minimizing the landing position deviation of the ink on the recording medium M at the predetermined distance PG is obtained, and the circulation mechanism 60 does not circulate ink at the excessive flow rate and waste power.

Specifically, as illustrated in FIG. 5, when the distance PG is set to 1 mm using the A1 ink, and the circulation flow rate by the circulation mechanism 60 is a flow rate S1 or more, the landing deviation amount of the ink on the recording medium M is saturated. When the distance PG is set to 3 mm using the A1 ink and the A3 ink, and the circulation flow rate by the circulation mechanism 60 is a flow rate S2 or more, the landing deviation amount of the ink on the recording medium M is saturated. When the distance PG is set to 5 mm using the A1 ink and the A3 ink, and the circulation flow rate by the circulation mechanism 60 is a flow rate S3 or more, the landing deviation amount of the ink on the recording medium M is saturated.

In addition, as illustrated in FIG. 6, when the distance PG is set to 1 mm, and the circulation flow rate by the circulation mechanism 60 is a flow rate S4 or more, the landing deviation amount of the ink on the recording medium M is saturated. When the distance PG is set to 5 mm, and the circulation flow rate by the circulation mechanism 60 is a flow rate S5 or more, the landing deviation amount of the ink on the recording medium M is saturated.

In the related art, even when the distance PG is changed after the flow rate, at the time when the landing deviation amount of the ink on the recording medium M is saturated, is set as the setting value of the circulation flow rate by the circulation mechanism 60, when the distance PG is a specific value, the setting value is used.

However, the flow rate at the time when the landing deviation amount of the ink on the recording medium M is saturated differs depending on the distance PG as illustrated in FIGS. 5 and 6. Therefore, for example, when the actual distance PG is greater than the distance PG used for setting the setting value, the landing deviation amount of the ink on the recording medium M cannot be sufficiently reduced, and as a result, there is a concern that the printing quality defect may occur. In addition, when the actual distance PG is smaller than the distance PG used for setting the setting value, the excessive flow rate by the circulation mechanism 60 is circulated, and there is a concern that power may be wasted.

### 1-5. Drive Method of Liquid Ejecting Apparatus

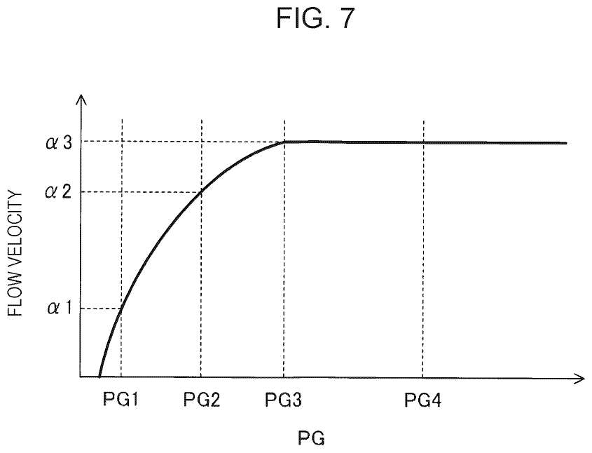

FIG. 7 is a view illustrating a relationship between the distance PG between the nozzle surface FN and the recording medium M, and the circulation flow rate by the circulation mechanism 60 in which the landing deviation amount is saturated. In FIG. 7, the horizontal axis indicates the distance PG, and the vertical axis indicates the circulation flow rate by the circulation mechanism 60. Here, the flow rate corresponds to the flow rate at the time when the landing deviation amount of the ink on the recording medium M is saturated. Hereinafter, a case where the liquid ejecting apparatus 100 has a configuration in which the distance PG can be changed from a first distance PG1 to a third distance PG3 will be described.

In the liquid ejecting apparatus 100, as illustrated in FIG. 7, the circulation flow rate by the circulation mechanism 60 is adjusted according to the distance PG, which is an example of the print condition. Therefore, even when a print condition is changed, the circulation amount of the ink can be optimized, and as a result, it is possible to reduce the printing quality defect and the waste of power. For example, information indicating the relationship between the distance PG between the nozzle surface FN and the recording medium M, and the circulation flow rate by the circulation mechanism 60 in which the landing deviation amount is saturated can be acquired in advance by an experiment or the like, and data based on the acquired information can be stored in the storage circuit 22 of the liquid ejecting apparatus 100.

In the drive method of the liquid ejecting apparatus 100, after a print condition information acquisition section 21a acquires the print condition information DP1, the circulation control section 21b controls the flow velocity of the ink in the individual flow path PJ based on the print condition information DP1. Therefore, even when a print condition is changed, a circulation amount of the ink can be optimized. As a result, it is possible to reduce the printing quality defect and the waste of power.

The ink ejected from the nozzle N that opens on the nozzle surface FN lands on the recording medium M. The degree of progress of thickening of the ink in the nozzle N changes depending on the magnitude of the distance PG between the nozzle surface FN and the recording medium M. In addition, the landing position of the ink on the recording medium M changes due to the change in the speed of the ink ejected from the nozzle N or the change in the flight direction, according to the viscosity of the ink in the nozzle N. Further, the greater the distance PG between the nozzle surface FN and the recording medium M, the greater the change in the landing position due to the change in the speed and the flight direction of the ink ejected from the nozzle N. That is, when the distance PG between the nozzle surface FN and the recording medium M is changed, the influence of the landing error due to the thickening of the ink on the recording medium M changes. Therefore, the circulation control section 21b controls the flow velocity of the ink in the individual flow path PJ based on the distance information DG. As a result, even when the distance PG between the nozzle surface FN and the recording medium M is changed, it is possible to reduce the printing quality defect and the waste of power by optimizing the circulation amount of the ink.

In the example illustrated in FIG. 7, when the distance PG is the third distance PG3 or less, the circulation control section 21b can reduce the landing position deviation amount of the ink on the recording medium M by increasing the flow velocity of the ink in the individual flow path PJ as the distance PG increases. On the other hand, when the distance PG is longer than the third distance PG3, the landing position deviation amount of the ink on the recording medium M cannot be reduced even when the flow velocity of the ink in the individual flow path PJ is increased to be greater than a third flow velocity α3. Therefore, the flow velocity of the ink in the individual flow path PJ is set to be constant at the third flow velocity α3 regardless of the magnitude of the distance PG, and thus the waste of power is reduced.

Here, when the distance information DG indicates the first distance PG1, the circulation control section 21b controls the flow velocity of the ink in the individual flow path PJ to a first flow velocity α1. When the distance information DG indicates a second distance PG2 longer than the first distance PG1, the circulation control section 21b controls the flow velocity of the ink in the individual flow path PJ to a second flow velocity α2 faster than the first flow velocity α1. Similarly, when the distance information DG indicates the third distance PG3 longer than the first distance PG1 and the second distance PG2, the circulation control section 21b controls the flow velocity of the ink in the individual flow path PJ to the third flow velocity α3 faster than the first flow velocity α1 and the second flow velocity α2. As a result, even when the distance PG between the nozzle surface FN and the recording medium M is increased, the flow velocity of the ink in the individual flow path PJ is increased. Therefore, by reducing the thickening of the ink, it is possible to reduce the influence of the landing error due to the thickening of the ink. Therefore, even when the distance PG between the nozzle surface FN and the recording medium M is increased, it is possible to reduce the printing quality defect. On the other hand, in a state where the distance PG between the nozzle surface FN and the recording medium M is short, the flow velocity of the ink in the individual flow path PJ is reduced, so that it is possible to reduce the waste of power.

When the distance information DG indicates the third distance PG3 or more, the third distance PG3 being longer than the second distance PG2, the circulation control section 21b controls the flow velocity of the ink in the individual flow path PJ to the third flow velocity α3 faster than the second flow velocity α2. As described above, in a fourth distance PG4, which is the third distance PG3 or more, even when the flow velocity of the ink in the individual flow path PJ is set to the third flow velocity α3 or more, the landing position deviation amount of the ink on the recording medium M cannot be reduced more than the case of the third flow velocity α3. Therefore, the circulation control section 21b controls the flow velocity of the ink in the individual flow path PJ to be maintained at the third flow velocity α3. As a result, it is possible to prevent the flow velocity of the ink in the individual flow path PJ from being unnecessarily increased and to reduce the waste of power.

When the distance information DG indicates the second distance PG2 between the first distance PG1 and the third distance PG3, the circulation control section 21b controls the flow velocity of the ink in the individual flow path PJ to the second flow velocity α2 between the first flow velocity α1 and the third flow velocity α3. In a state where the flow velocity of the ink in the individual flow path PJ is controlled to the third flow velocity α3, when the distance information DG of the print condition information DP1 acquired by the print condition information acquisition section 21a is the first distance PG1 shorter than the third distance PG3, the circulation control section 21b controls the flow velocity of the ink in the individual flow path PJ to the first flow velocity α1 slower than the third flow velocity α3. As a result, the flow velocity of the ink in the individual flow path PJ can be changed stepwise in accordance with the distance PG between the nozzle surface FN and the recording medium M. Therefore, it is possible to preferably reduce the waste of power and the printing quality defect.

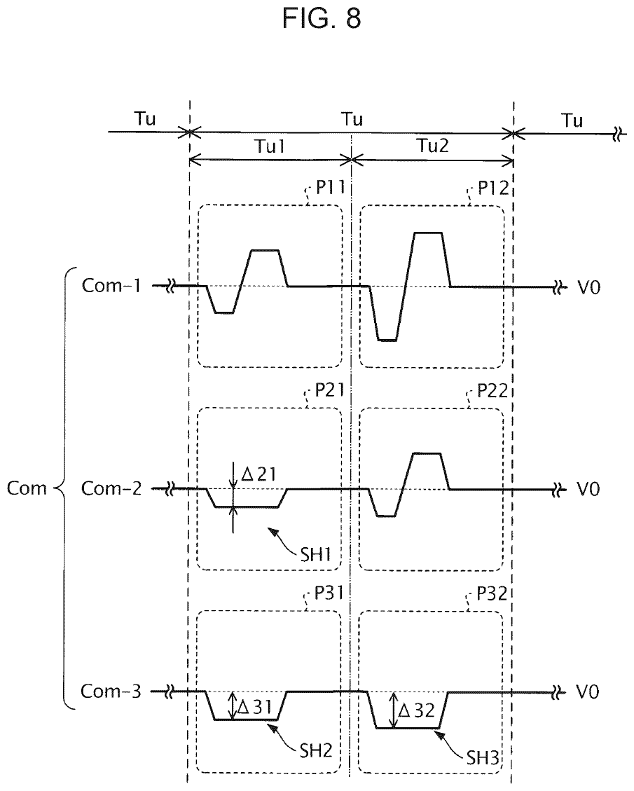

FIG. 8 is an explanatory view of the drive signal Com that is supplied to the drive element 51e. As illustrated in FIG. 8, the drive signal Com includes drive signals Com-1, Com-2, and Com-3. Each of the drive signals Com-1, Com-2, and Com-3 is a signal having a waveform that is repeated in a unit period Tu. The drive signal Com need only include necessary pulses to be selectable by the operation of the drive circuit 51i, and is not limited to the aspect that is configured with three drive signals, may be configured with two or fewer drive signals, or may be configured with four or more drive signals.

The unit period Tu corresponds to a print cycle in which dots are formed on the recording medium M by the ink from nozzle N. Further, the unit period Tu is divided into a control period Tu1 and a control period Tu2. The drive circuit 51i is configured to select any of the waveforms of the drive signals Com-1, Com-2, and Com-3 for each of the control periods Tu1 and Tu2. In addition, in the example illustrated in FIG. 8, the control period Tu1 and the control period Tu2 have the same time length, but are not limited thereto, and the control period Tu1 and the control period Tu2 may have different time lengths. Further, the unit period Tu may be divided into three or more control periods.

The drive signal Com-1 includes an ejection pulse P11 provided in the control period Tu1 and an ejection pulse P12 provided in the control period Tu2. The drive signal Com-2 includes a micro-vibration pulse P21 provided in the control period Tu1 and an ejection pulse P22 provided in the control period Tu2. The drive signal Com-3 includes a micro-vibration pulse P31 provided in the control period Tu1 and a micro-vibration pulse P32 provided in the control period Tu2. As described above, the drive signal Com includes the ejection pulses P11, P12, and P22 and the micro-vibration pulses P21, P31, and P32.

Each of the ejection pulses P11, P12, and P22 is a potential pulse for driving the drive element 51e so that pressure fluctuation having a strength that the ink is ejected from the nozzle N occurs in the pressure chambers Ca and Cb.

The pressure fluctuation in the pressure chambers Ca and Cb due to the ejection pulse P12 is greater than the pressure fluctuation in the pressure chambers Ca and Cb due to the ejection pulse P11 or the ejection pulse P22. Therefore, for example, by using the ejection pulse P12, it is possible to eject an amount of ink corresponding to a large dot from the nozzle N as compared with the case of using the ejection pulse P11 or the ejection pulse P22. Further, by using the ejection pulses P11 and P12 within the same unit period Tu, it is possible to eject an amount of ink corresponding to a large dot from the nozzle N as compared with a case where the ejection pulse P12 is used alone. As described above, by appropriately switching between the case where the ejection pulse P11 or the ejection pulse P22 is used alone, the case where the ejection pulse P12 is used alone, and the case where the ejection pulses P11 and P12 are used, for each unit period Tu, it is possible to selectively eject an amount of ink corresponding to a small dot, a medium dot, and a large dot from the nozzle N. The waveforms of the ejection pulses P11, P12, and P22 are not limited to the example illustrated in FIG. 8, and are any waveforms.

On the other hand, the micro-vibration pulses P21, P31, and P32 are potential pulses for driving the drive element 51e so that pressure fluctuation having a strength that the ink is not ejected from the nozzle N occurs in the pressure chambers Ca and Cb. That is, each of the micro-vibration pulses P21, P31, and P32 causes pressure fluctuation to occur in the ink in the individual flow path PJ to an extent that the ink is not ejected from the nozzle N.

The pressure fluctuation in the pressure chambers Ca and Cb due to the micro-vibration pulse P21 is smaller than the pressure fluctuation in the pressure chambers Ca and Cb due to the micro-vibration pulse P31. On the other hand, the pressure fluctuation in the pressure chambers Ca and Cb due to the micro-vibration pulse P32 is greater than the pressure fluctuation in the pressure chambers Ca and Cb due to the micro-vibration pulse P31. Here, the micro-vibration pulse P21 has a first pulse shape SH1 that causes first pressure fluctuation to occur in the ink in the individual flow path PJ. The micro-vibration pulse P31 has a second pulse shape SH2 that causes second pressure fluctuation greater than the first pressure fluctuation to occur in the ink in the individual flow path PJ. The micro-vibration pulse P32 has a third pulse shape SH3 that causes third pressure fluctuation greater than the second pressure fluctuation to occur in the ink in the individual flow path PJ. The waveforms of the micro-vibration pulses P21, P31, and P32 are not limited to the example illustrated in FIG. 8, and are any waveforms.

In the drawing, a potential change width ΔV31 of a potential change component of the micro-vibration pulse P31 is greater than a potential change width ΔV21 of a potential change component of the micro-vibration pulse P21. As a result, it is possible to cause the second pressure fluctuation greater than the first pressure fluctuation to occur in the ink in the individual flow path PJ by using the micro-vibration pulse P31. Similarly, a potential change width ΔV32 of a potential change component of the micro-vibration pulse P32 is greater than the potential change width ΔV31 of the potential change component of the micro-vibration pulse P31. As a result, it is possible to cause the third pressure fluctuation greater than the second pressure fluctuation to occur in the ink in the individual flow path PJ by using the micro-vibration pulse P32.

In addition, in order to change the magnitude of the pressure fluctuation due to the micro-vibration pulse, the magnitude of the pressure fluctuation can be changed by changing one of the potential change width of the potential change component of the micro-vibration pulse as described above, a potential change rate of the potential change component of the micro-vibration pulse, a pulse width which is an interval between the potential change components of the micro-vibration pulse, and the number of the potential change components included in the micro-vibration pulse, or by changing two or more of the changes in a combination.

In the unit period Tu in which dots are not formed, by supplying any of the micro-vibration pulses P21, P31, and P32 to the drive element 51e, the ink in the vicinity of the meniscus in the nozzle N is agitated with the ink circulating in the individual flow path PJ to suppress the thickening of the ink in the vicinity of the meniscus in the nozzle N.

The circulation control section 21b corrects the micro-vibration pulse by selecting and using any of the micro-vibration pulses P21, P31, and P32 based on the print condition information DP1 so that the pressure fluctuation caused to occur in the liquid in the individual flow path PJ is changed. As a result, even when the print condition is changed, the pressure fluctuation of the ink in the individual flow path PJ by the micro-vibration pulse is adjusted, so that it is possible to reduce the waste of power and reduce the printing quality defect.

More specifically, when the distance information DG indicates the first distance PG1, the circulation control section 21b uses the micro-vibration pulse P21 to cause the first pressure fluctuation to occur in the ink in the individual flow path PJ. When the distance information DG indicates the second distance PG2, the circulation control section 21b causes the second pressure fluctuation to occur in the ink in the individual flow path PJ by using the micro-vibration pulse P31. When the distance information DG indicates the third distance PG3, the circulation control section 21b causes the third pressure fluctuation to occur in the ink in the individual flow path PJ by using the micro-vibration pulse P32.

By using the micro-vibration pulses P21, P31, and P32 according to the distance PG in this manner, even when the distance PG between the nozzle surface FN and the recording medium M becomes longer, the pressure fluctuation of the ink in the individual flow path PJ due to the micro-vibration pulse becomes greater. Therefore, the effect of reducing the thickening of the ink in the vicinity of the meniscus in the nozzle N by increasing the agitation with the circulating ink is enhanced, and the influence of the landing error due to the thickening of the ink can be reduced. In addition, when the distance PG between the nozzle surface FN and the recording medium M is reduced, the pressure fluctuation of the ink in the individual flow path PJ due to the micro-vibration pulse is reduced. Therefore, the circulating ink is not excessively agitated, and it is possible to reduce the printing quality defect while reducing the waste of power.

### 2. Second Embodiment

Hereinafter, a second embodiment of the present disclosure will be described. In the embodiment to be described below, elements having the same effects and functions as those of the first embodiment will be denoted by the reference numerals used in the description of the first embodiment, and each of the elements will not be described in detail, as appropriate.

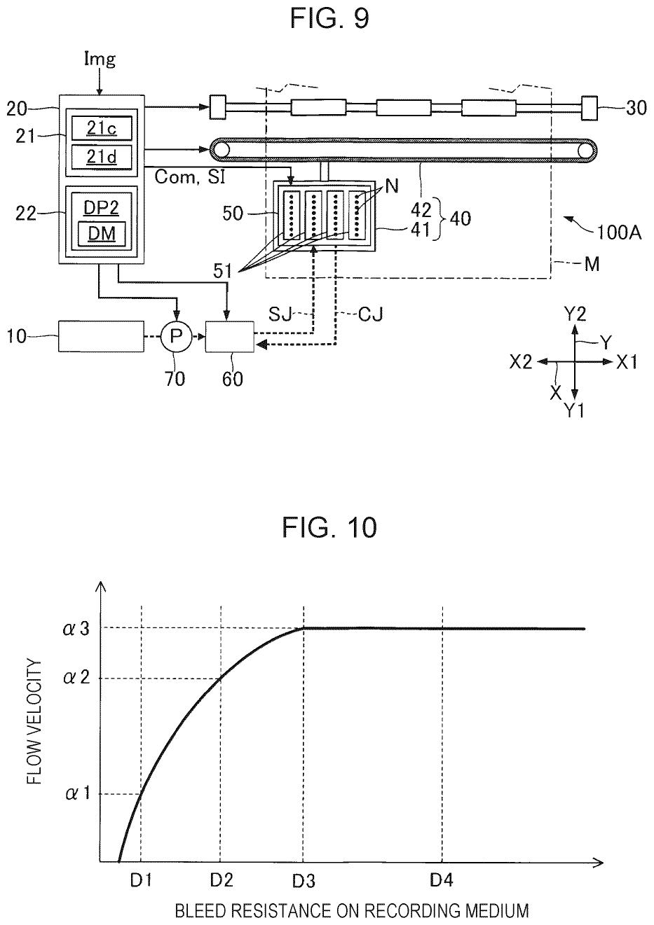

FIG. 9 is a schematic view illustrating a configuration example of a liquid ejecting apparatus 100A according to a second embodiment. The liquid ejecting apparatus 100A is configured in the same manner as the liquid ejecting apparatus 100 of the first embodiment, except that the operation of the circulation mechanism 60 is controlled by using the print condition information DP2 instead of the print condition information DP1.

The print condition information DP2 includes medium information DM as information regarding the print condition of the ink ejected from the nozzle N on the recording medium M. The medium information DM is information regarding the type of the recording medium M on which the ink ejected from the nozzle N lands. The degree of bleed resistance of the ink on the recording medium M varies depending on the type of the recording medium M. Therefore, it can be said that the medium information DM is information indicating the degree of the bleed resistance of the ink on the recording medium M.

In the present embodiment, the processing circuit 21 functions as the print condition information acquisition section 21c and the circulation control section 21d. Therefore, the liquid ejecting apparatus 100A includes the circulation control section 21d and the print condition information acquisition section 21c. The print condition information acquisition section 21c acquires the print condition information DP2. The acquired print condition information DP2 is stored in the storage circuit 22. The circulation control section 21d controls the flow velocity of the ink in the individual flow path PJ based on the print condition information DP2. Therefore, even when a print condition is changed, a circulation amount of the ink can be optimized. As a result, it is possible to reduce the printing quality defect and the waste of power.

The acquisition of the print condition information DP2 by the print condition information acquisition section 21c is performed, for example, by an input of the medium type setting or the like by the user.

FIG. 10 is a view illustrating a relationship between the bleed resistance of the ink on the recording medium M and the circulation flow rate by the circulation mechanism 60. In FIG. 10, the horizontal axis indicates the degree of the bleed resistance on the recording medium M, and the vertical axis indicates the circulation flow rate by the circulation mechanism 60. Here, the flow rate corresponds to a flow rate at the time when the improvement in printing quality due to a decrease in the landing deviation amount of the ink on the recording medium M is saturated. In the following, a case where it is assumed that the degree of the bleed resistance on the recording medium M may change from a first degree D1 to a fourth degree D4 will be described. For example, information indicating the relationship between the degree of the bleed resistance on the recording medium M or the type of the recording medium M, and the circulation flow rate by the circulation mechanism 60 at which the improvement in printing quality due to the landing deviation of the ink on the recording medium M is saturated, can be acquired in advance by an experiment or the like, and data based on the acquired information can be stored in the storage circuit 22 of the liquid ejecting apparatus 100A.

In the drive method of the liquid ejecting apparatus 100A, the circulation control section 21d controls the flow velocity of the ink in the individual flow path PJ based on the print condition information DP2. Therefore, even when a print condition is changed, a circulation amount of the ink can be optimized. As a result, it is possible to reduce the printing quality defect and the waste of power.

In the recording medium M in which ink easily bleeds, ink droplets that have landed on the recording medium M spread on the recording medium M, and thus the ratio of the landing deviation amount of the ink droplets to the dot diameter that has spread is small, and even when the landing deviation amount of the ink droplets is a predetermined amount, the printing quality deterioration is hardly visually recognized. On the other hand, in the recording medium M in which ink is less likely to bleed, ink droplets that have landed on the recording medium M do not bleed on the recording medium M, and the ratio of the landing deviation amount of the ink droplets to the dot diameter is large as compared with the case of the recording medium M in which ink easily bleeds, and the printing quality deterioration is easily visually recognized even when the landing deviation amount of the ink droplets is small. Therefore, in the recording medium M in which ink is less likely to bleed, the landing error of the ink on the recording medium M is more noticeable than in the recording medium M in which ink easily bleeds, the landing deviation amount of the ink on the recording medium M in which the printing quality deterioration is allowed is small, and the flow rate at the time when the improvement in the printing quality due to the decrease in the landing deviation amount is saturated is great. Therefore, the circulation control section 21d controls the flow velocity of the ink in the individual flow path PJ based on the medium information DM. As a result, even when the type of the recording medium M is changed, it is possible to reduce the printing quality defect and the waste of power by optimizing the circulation amount of the ink.

In the example illustrated in FIG. 10, when the degree of the bleed resistance on the recording medium M is a third degree D3 or less, the circulation control section 21d can reduce the landing position deviation amount of the ink on the recording medium M until the printing quality can be improved by increasing the flow velocity of the ink in the individual flow path PJ as the degree of the bleed resistance on the recording medium M increases. On the other hand, when the degree of the bleed resistance on the recording medium M is greater than the third degree D3, the landing position deviation amount of the ink on the recording medium M cannot be reduced even when the flow velocity of the ink in the individual flow path PJ is increased to be greater than the third flow velocity α3. Therefore, the flow velocity of the ink in the individual flow path PJ is set to be constant at the third flow velocity α3 regardless of the magnitude of the degree of the bleed resistance on the recording medium M, and thus the waste of power is reduced.

Here, when the medium information DM indicates the first degree D1, the circulation control section 21d controls the flow velocity of the ink in the individual flow path PJ to the first flow velocity α1. When the medium information DM indicates a second degree D2 greater than the first degree D1, the circulation control section 21d controls the flow velocity of the ink in the individual flow path PJ to the second flow velocity α2 faster than the first flow velocity α1. Similarly, when the medium information DM indicates the third degree D3 greater than the first degree D1 and the second degree D2, the circulation control section 21d controls the flow velocity of the ink in the individual flow path PJ to the third flow velocity α3 faster than the first flow velocity α1 and the second flow velocity α2. As a result, as the recording medium M is less likely to bleed, the flow velocity of the ink in the individual flow path PJ becomes faster. Therefore, by reducing the thickening of the ink, it is possible to reduce the influence of the landing error due to the thickening of the ink.

When the medium information DM indicates the third degree D3 or more, the third degree being greater than the second degree D2, the circulation control section 21d controls the flow velocity of the ink in the individual flow path PJ to the third flow velocity α3 faster than the second flow velocity α2. As described above, in a fourth degree D4, which is the third degree D3 or more, even when the flow velocity of the ink in the individual flow path PJ is set to the third flow velocity α3 or more, the landing position deviation amount of the ink on the recording medium M cannot be reduced more than the case of the third flow velocity α3. Therefore, the circulation control section 21d controls the flow velocity of the ink in the individual flow path PJ to be maintained at the third flow velocity α3. As a result, it is possible to prevent the flow velocity of the ink in the individual flow path PJ from being unnecessarily increased and to reduce the waste of power.

When the medium information DM indicates the second degree D2 between the first degree D1 and the third degree D3, the circulation control section 21d controls the flow velocity of the ink in the individual flow path PJ to the second flow velocity α2 between the first flow velocity α1 and the third flow velocity α3. In a state where the flow velocity of the ink in the individual flow path PJ is controlled to the third flow velocity α3,when the medium information DM of the print condition information DP2 acquired by the print condition information acquisition section 21c is the first degree D1 smaller than the third degree D3, the circulation control section 21d controls the flow velocity of the ink in the individual flow path PJ to the first flow velocity α1 slower than the third flow velocity α3. As a result, the flow velocity of the ink in the individual flow path PJ can be changed stepwise according to the degree of the bleed resistance on the recording medium M. Therefore, it is possible to preferably reduce the waste of power and the printing quality defect.

As described above, the circulation control section 21d controls the flow velocity of the ink in the individual flow path PJ based on the medium information DM. As a result, even when the type of the recording medium M is changed, it is possible to reduce the printing quality defect and the waste of power by optimizing the circulation amount of the ink.

According to the above-described second embodiment, it is also possible to reduce the printing quality defect and the waste of power.

### 3. Third Embodiment

Hereinafter, a third embodiment of the present disclosure will be described. In the embodiment to be described below, elements having the same effects and functions as those of the first embodiment will be denoted by the reference numerals used in the description of the first embodiment, and each of the elements will not be described in detail, as appropriate.

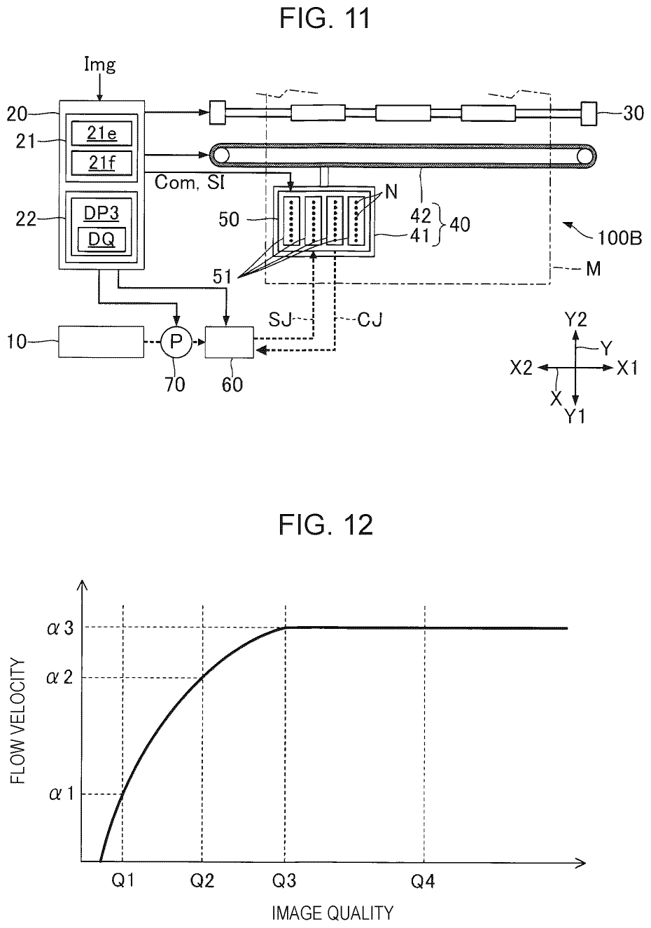

FIG. 11 is a schematic view illustrating a configuration example of a liquid ejecting apparatus 100B according to a third embodiment. The liquid ejecting apparatus 100B is configured in the same manner as the liquid ejecting apparatus 100 of the first embodiment, except that the operation of the circulation mechanism 60 is controlled by using print condition information DP3 instead of the print condition information DP1.

The print condition information DP3 includes image quality information DQ as information regarding the print condition of the ink ejected from the nozzle N on the recording medium M. The image quality information DQ is information regarding the printing image quality required for the recording medium M by the ink ejected from the nozzle N. It can be said that the image quality information DQ is information indicating the degree of printing image quality on the recording medium M required by the user.

In the present embodiment, the processing circuit 21 functions as a print condition information acquisition section 21e and a circulation control section 21f. Therefore, the liquid ejecting apparatus 100B includes the circulation control section 21f and the print condition information acquisition section 21e. The print condition information acquisition section 21e acquires the print condition information DP3. The acquired print condition information DP3 is stored in the storage circuit 22. The circulation control section 21f controls the flow velocity of the ink in the individual flow path PJ based on the print condition information DP3. Therefore, even when a print condition is changed, a circulation amount of the ink can be optimized. As a result, it is possible to reduce the printing quality defect and the waste of power.

The acquisition of the print condition information DP3 by the print condition information acquisition section 21e is performed, for example, by an input of the image quality setting or the like by the user.

FIG. 12 is a view illustrating a relationship between image quality and the circulation flow rate by the circulation mechanism 60. In FIG. 12, the horizontal axis indicates the degree of printing image quality required for the recording medium M, and the vertical axis indicates the circulation flow rate by the circulation mechanism 60. Here, the flow rate corresponds to a flow rate corresponding to a maximum amount at which the landing deviation amount of the ink on the recording medium M satisfies the required printing image quality. Hereinafter, a case where it is assumed that the degree of printing image quality on the recording medium M can change from first image quality Q1 to fourth image quality Q4 will be described. For example, information indicating the relationship between the required printing image quality and the circulation flow rate by the circulation mechanism 60 corresponding to the landing deviation maximum amount of the ink that can satisfy the required printing image quality is acquired in advance by an experiment or the like, and data based on the acquired information can be stored in the storage circuit 22 of the liquid ejecting apparatus 100B.

In the drive method of the liquid ejecting apparatus 100B, the circulation control section 21f controls the flow velocity of the ink in the individual flow path PJ based on the print condition information DP3. Therefore, even when a print condition is changed, a circulation amount of the ink can be optimized. As a result, it is possible to reduce the printing quality defect and the waste of power.

When the degree of the printing image quality required for the recording medium M is high, the high accuracy for the landing position of the ink on the recording medium M is required as compared with a case where the degree of the printing image quality required for the recording medium M is low. Therefore, the circulation control section 21f controls the flow velocity of the ink in the individual flow path PJ based on the image quality information DQ. As a result, it is possible to reduce a printing quality defect and waste of power by optimizing the circulation amount of the ink according to the setting of the printing image quality.

In the example illustrated in FIG. 12, when the degree of printing image quality is third image quality Q3 or lower, the circulation control section 21f can reduce the landing position deviation amount of the ink on the recording medium M until the required printing image quality can be achieved by increasing the flow velocity of the ink in the individual flow path PJ as the degree of the required printing image quality increases. On the other hand, when the degree of the required printing image quality is higher than the third image quality Q3, the landing position deviation amount of the ink on the recording medium M cannot be reduced even when the flow velocity of the ink in the individual flow path PJ is increased to be greater than the third flow velocity α3. Therefore, the flow velocity of the ink in the individual flow path PJ is set to be constant at the third flow velocity α3 regardless of the degree of the required printing image quality, and thus the waste of power is reduced.

Here, when the image quality information DQ indicates the first image quality Q1, the circulation control section 21f controls the flow velocity of the ink in the individual flow path PJ to the first flow velocity α1. When the image quality information DQ indicates a second image quality Q2 having higher image quality than the first image quality Q1, the circulation control section 21f controls the flow velocity of the ink in the individual flow path PJ to the second flow velocity α2 faster than the first flow velocity α1. Similarly, when the image quality information DQ indicates a third image quality Q3 having higher image quality than the first image quality Q1 and the second image quality Q2, the circulation control section 21f controls the flow velocity of the ink in the individual flow path PJ to the third flow velocity α3 faster than the first flow velocity α1 and the second flow velocity α2. As a result, when the printing image quality is changed, the circulation amount of the ink is optimized, so that it is possible to reduce the printing quality defect and the waste of power.

When the image quality information DQ indicates the third image quality Q3 or higher, the third image quality Q3 having higher image quality than the second image quality Q2, the circulation control section 21f controls the flow velocity of the ink in the individual flow path PJ to the third flow velocity α3 faster than the second flow velocity α2. As described above, in the fourth image quality Q4, which is the third image quality Q3 or higher, even when the flow velocity of the ink in the individual flow path PJ is set to the third flow velocity α3 or more, the landing position deviation amount of the ink on the recording medium M cannot be reduced more than the case of the third flow velocity α3. Therefore, the circulation control section 21f controls the flow velocity of the ink in the individual flow path PJ to be maintained at the third flow velocity α3. Therefore, it is also possible to notify the user that the printable high image quality is up to the third image quality Q3. As a result, it is possible to prevent the flow velocity of the ink in the individual flow path PJ from being unnecessarily increased and to reduce the waste of power.

When the image quality information DQ indicates the second image quality Q2 between the first image quality Q1 and the third image quality Q3, the circulation control section 21f controls the flow velocity of the ink in the individual flow path PJ to the second flow velocity α2 between the first flow velocity α1 and the third flow velocity α3. Similarly, when the image quality information DQ indicates the third image quality Q3 higher than the first image quality Q1 and the second image quality Q2, the circulation control section 21f controls the flow velocity of the ink in the individual flow path PJ to the third flow velocity α3 faster than the first flow velocity α1 and the second flow velocity α2. In a state where the flow velocity of the ink in the individual flow path PJ is controlled to the third flow velocity α3, when the image quality information DQ of the print condition information DP3 acquired by the print condition information acquisition section 21e is the first image quality Q1 lower than the third image quality Q3, the circulation control section 21f controls the flow velocity of the ink in the individual flow path PJ to the first flow velocity α1 slower than the third flow velocity α3. In addition, when the image quality information DQ indicates the third image quality Q3 or higher, the third image quality Q3 being higher than the second image quality Q2, the circulation control section 21f controls the flow velocity of the ink in the individual flow path PJ to the third flow velocity α3 faster than the second flow velocity α2. In addition, when the image quality information DQ indicates the second image quality Q2 between the first image quality Q1 and the third image quality Q3, the circulation control section 21f controls the flow velocity of the ink in the individual flow path PJ to the second flow velocity α2 between the first flow velocity α1 and the third flow velocity α3. As a result, the flow velocity of the ink in the individual flow path PJ can be changed stepwise in response to the requirement of the printing image quality. Therefore, it is possible to preferably reduce the waste of power and the printing quality defect.

According to the above-described third embodiment, it is also possible to reduce the printing quality defect and the waste of power.

### 4. Modification Examples

Each of the above-described embodiments can be variously modified. Specific modification aspects will be described below. Two or more aspects optionally selected from the following examples can be appropriately merged to an extent that the aspects do not contradict each other.

### 4-1. Modification Example 1

Two or more embodiments may be combined among the first to third embodiments described above. That is, the flow velocity of the ink in the individual flow path PJ may be controlled based on the print condition information including two or more of the distance information DG, the medium information DM, and the image quality information DQ.

### 4-2. Modification Example 2

In each of the above-described embodiments, an aspect of correcting the micro-vibration pulse based on the print condition information DP1, DP2, and DP3 is described, but the present disclosure is not limited to the aspect, and the correction of the micro-vibration pulse may be omitted.

### 4-3. Modification Example 3

The above-described liquid ejecting apparatuses 100, 100A, and 100B can be adopted in various devices such as a facsimile machine and a copying machine, in addition to a device dedicated to printing. However, the application of the liquid ejecting apparatus of the present disclosure is not limited to printing. For example, a liquid ejecting apparatus that ejects a solution of a coloring material is used as a manufacturing device that forms a color filter of a liquid crystal display device. In addition, a liquid ejecting apparatus that ejects a solution of a conductive material is used as a manufacturing device that forms wiring or an electrode of a wiring substrate.

### 5. Appendix

The present disclosure is summarized as follows.

Appended 1. According to a first aspect, which is a preferred example of the drive method of a liquid ejecting apparatus of the present disclosure, a drive method of a liquid ejecting apparatus including a liquid ejecting head that includes a nozzle that ejects liquid, an individual flow path that communicates with the nozzle and discharges liquid that is not ejected from the nozzle while supplying liquid to the nozzle, and a drive element that drives so that pressure fluctuation occurs in the liquid in the individual flow path according to a supplied drive signal, a circulation control section that controls a circulation operation of circulating the liquid in the individual flow path, and a print condition information acquisition section that acquires print condition information regarding a print condition on a recording medium of the liquid ejected from the nozzle, the drive method includes controlling a flow velocity of the liquid in the individual flow path based on the print condition information via the circulation control section.

In the above aspect, since the circulation control section controls the flow velocity of the liquid in the individual flow path based on the print condition information, the circulation amount of the ink can be optimized even when the print condition is changed. As a result, it is possible to reduce the printing quality defect and the waste of power.

Appended 2. According to a second aspect, which is a preferred example of the first aspect, the print condition information includes distance information indicating a distance between a nozzle surface where the nozzle opens and a recording medium on which the liquid ejected from the nozzle lands. In the above aspect, even when the distance between the nozzle surface and the recording medium is changed, it is possible to reduce the printing quality defect and the waste of power by optimizing the circulation amount of the ink.

Appended 3. According to a third aspect, which is a preferred example of the second aspect, when the distance information indicates a first distance, the circulation control section controls the flow velocity of the liquid in the individual flow path to a first flow velocity, and when the distance information indicates a second distance longer than the first distance, the circulation control section controls the flow velocity of the liquid in the individual flow path to a second flow velocity faster than the first flow velocity. In the above aspect, even when the distance between the nozzle surface and the recording medium is increased, the flow velocity of the liquid in the individual flow path is increased. Therefore, by reducing the thickening of the liquid, it is possible to reduce the influence of the landing error due to the thickening of the liquid. Therefore, even when the distance between the nozzle surface and the recording medium is increased, it is possible to reduce the printing quality defect. On the other hand, in a state where the distance between the nozzle surface and the recording medium is short, the flow velocity of the liquid in the individual flow path is reduced, so that it is possible to reduce the waste of power.

Appended 4. According to a fourth aspect, which is a preferred example of the third aspect, the drive signal includes a micro-vibration pulse that causes pressure fluctuation to occur in the liquid in the individual flow path to an extent that the liquid is not ejected from the nozzle, when the distance information indicates the first distance, the micro-vibration pulse has a first pulse shape that causes first pressure fluctuation to occur in the liquid in the individual flow path, and when the distance information indicates the second distance, the micro-vibration pulse has a second pulse shape that causes second pressure fluctuation greater than the first pressure fluctuation to occur in the liquid in the individual flow path. In the above aspect, even when the distance between the nozzle surface and the recording medium is increased, the pressure fluctuation of the liquid in the individual flow path due to the micro-vibration pulse is increased. Therefore, the effect of reducing the thickening of the liquid by the circulation is enhanced, and thus the influence of the landing error due to the thickening of the liquid can be reduced. Therefore, even when the distance between the nozzle surface and the recording medium is changed, it is possible to reduce the printing quality defect while reducing the waste of power.

Appended 5. According to a fifth aspect, which is a preferred example of the third aspect, when the distance information indicates a third distance or more, the third distance being longer than the second distance, the circulation control section controls the flow velocity of the liquid in the individual flow path to a third flow velocity faster than the second flow velocity. In the above aspect, it is possible to reduce the increase in the flow velocity of the liquid in the individual flow path more than necessary. Therefore, it is possible to reduce the waste of power.

Appended 6. According to a sixth aspect, which is a preferred example of any of the first to fifth aspects, the print condition information includes medium information regarding a type of a recording medium on which the liquid ejected from the nozzle lands. In the above aspect, even when the type of the recording medium is changed, it is possible to reduce the printing quality defect and the waste of power by optimizing the circulation amount of the ink.

Appended 7. According to a seventh aspect, which is a preferred example of any of the first to sixth aspects, the print condition information is image quality information regarding printing image quality on a recording medium by the liquid ejected from the nozzle, when the image quality information indicates first image quality, the circulation control section controls the flow velocity of the liquid in the individual flow path to a first flow velocity, and when the image quality information indicates second image quality having higher image quality than the first image quality, the circulation control section controls the flow velocity of the liquid in the individual flow path to a second flow velocity faster than the first flow velocity. In the above aspect, even when the printing image quality is changed, it is possible to reduce the printing quality defect and the waste of power by optimizing the circulation amount of the ink.

Appended 8. According to an eighth aspect, which is a preferred example of any of the first to seventh aspects, the drive signal includes a micro-vibration pulse that causes pressure fluctuation to occur in the liquid in the individual flow path to an extent that the liquid is not ejected from the nozzle, and the micro-vibration pulse is corrected, based on the print condition information, so that the pressure fluctuation caused to occur in the liquid in the individual flow path is changed. In the above aspect, even when the print condition is changed, the pressure fluctuation of the liquid in the individual flow path by the micro-vibration pulse is adjusted, so that it is possible to reduce the printing quality defect while reducing the waste of power.

Appended 9. According to a ninth aspect, which is a preferred example of the liquid ejecting apparatus of the present disclosure, a liquid ejecting apparatus includes a liquid ejecting head that includes a nozzle that ejects liquid, an individual flow path that communicates with the nozzle and discharges liquid that is not ejected from the nozzle while supplying liquid to the nozzle, and a drive element that drives so that pressure fluctuation occurs in the liquid in the individual flow path according to a supplied drive signal, a circulation control section that controls a circulation operation of circulating the liquid in the individual flow path, and a print condition information acquisition section that acquires print condition information regarding a print condition on a recording medium of the liquid ejected from the nozzle, and the circulation control section controls a flow velocity of the liquid in the individual flow path based on the print condition information.

In the above aspect, since the circulation control section controls the flow velocity of the liquid in the individual flow path based on the print condition information, the circulation amount of the ink can be optimized even when the print condition is changed. As a result, it is possible to reduce the printing quality defect and the waste of power.

What is claimed is:

1. A drive method of a liquid ejecting apparatus including
a liquid ejecting head that includes a nozzle that ejects liquid, an individual flow path that communicates with the nozzle and discharges liquid that is not ejected from the nozzle while supplying liquid to the nozzle, and a drive element that is configured to drive so that pressure fluctuation occurs in the liquid in the individual flow path according to a supplied drive signal,
a circulation control section that is configured to control a circulation operation of circulating the liquid in the individual flow path, and
a print condition information acquisition section that is configured to acquire print condition information regarding a print condition on a recording medium of the liquid ejected from the nozzle, the drive method comprising:
controlling a flow velocity of the liquid in the individual flow path based on the print condition information via the circulation control section.

2. The drive method of a liquid ejecting apparatus according to claim 1, wherein
the print condition information includes distance information indicating a distance between a nozzle surface where the nozzle opens and a recording medium on which the liquid ejected from the nozzle lands.

3. The drive method of a liquid ejecting apparatus according to claim 2, wherein
when the distance information indicates a first distance, the circulation control section controls the flow velocity of the liquid in the individual flow path to a first flow velocity, and
when the distance information indicates a second distance longer than the first distance, the circulation control section controls the flow velocity of the liquid in the individual flow path to a second flow velocity faster than the first flow velocity.

4. The drive method of a liquid ejecting apparatus according to claim 3, wherein
the drive signal includes a micro-vibration pulse that causes pressure fluctuation to occur in the liquid in the individual flow path to an extent that the liquid is not ejected from the nozzle,
when the distance information indicates the first distance, the micro-vibration pulse has a first pulse shape that causes first pressure fluctuation to occur in the liquid in the individual flow path, and
when the distance information indicates the second distance, the micro-vibration pulse has a second pulse shape that causes second pressure fluctuation greater than the first pressure fluctuation to occur in the liquid in the individual flow path.

5. The drive method of a liquid ejecting apparatus according to claim 3, wherein
when the distance information indicates a third distance or more, the third distance being longer than the second distance, the circulation control section controls the flow velocity of the liquid in the individual flow path to a third flow velocity faster than the second flow velocity.

6. The drive method of a liquid ejecting apparatus according to claim 1, wherein
the print condition information includes medium information regarding a type of a recording medium on which the liquid ejected from the nozzle lands.

7. The drive method of a liquid ejecting apparatus according to claim 1, wherein
the print condition information is image quality information regarding printing image quality on a recording medium by the liquid ejected from the nozzle,
when the image quality information indicates first image quality, the circulation control section controls the flow velocity of the liquid in the individual flow path to a first flow velocity, and
when the image quality information indicates second image quality having higher image quality than the first image quality, the circulation control section controls the flow velocity of the liquid in the individual flow path to a second flow velocity faster than the first flow velocity.

8. The drive method of a liquid ejecting apparatus according to claim 1, wherein
the drive signal includes a micro-vibration pulse that causes pressure fluctuation to occur in the liquid in the individual flow path to an extent that the liquid is not ejected from the nozzle, and
the micro-vibration pulse is corrected, based on the print condition information, so that the pressure fluctuation caused to occur in the liquid in the individual flow path is changed.

9. A liquid ejecting apparatus comprising:
a liquid ejecting head that includes a nozzle that ejects liquid, an individual flow path that communicates with the nozzle and discharges liquid that is not ejected from the nozzle while supplying liquid to the nozzle, and a drive element that is configured to drive so that pressure fluctuation occurs in the liquid in the individual flow path according to a supplied drive signal;
a circulation control section that is configured to control a circulation operation of circulating the liquid in the individual flow path; and
a print condition information acquisition section that is configured to acquire print condition information regarding a print condition on a recording medium of the liquid ejected from the nozzle, wherein
the circulation control section controls a flow velocity of the liquid in the individual flow path based on the print condition information.
